(19) United States
(12) Patent Application Publication
(10) Pub. No.: US 2014/0280377 A1
(43) Pub. Date: Sep. 18, 2014

(54) SYSTEMS AND METHODS FOR COLLABORATIVE DOCUMENT REVIEW

(71) Applicant: SCRIBESTAR LTD., London (GB)

(72) Inventor: Stephen John Frew, St Johns (GB)

(73) Assignee: SCRIBESTAR LTD., London (GB)

(21) Appl. No.: 13/830,832

(22) Filed: Mar. 14, 2013

(51) Int. Cl. G06F 17/30

(52) U.S. Cl. CPC G06F 17/30312
USPC 707/805

(57) ABSTRACT

Systems and methods for collaborative document review are disclosed. At least a portion of a hierarchical data structure is displayed. A first plurality of users has an edit privilege to edit the hierarchical data structure. A user selection of a region in the portion of the hierarchical data structure is obtained. In response to the user selection of the region, there is displayed, for each respective user in the first plurality of users, one or more edits associated with the respective user in a corresponding independent panel in a plurality of panels. This plurality of panels is displayed independently of the hierarchical data structure. In some instances, each user in a second plurality of users has review privileges to comment on the hierarchical data structure. One or more comments associated with a user in the second plurality of users is displayed in a same or different panel in the plurality of panels. A comment in the one or more comments is distinct from the one or more edits.

### RELATED APPLICATIONS

This application relates to U.S. patent application Ser. No. ______, filed on Mar. ______, 2013, attorney docket no. (070298-5002-US), which is hereby incorporated by reference in its entirety.

### TECHNICAL FIELD

The disclosed implementations relate generally to collaborative document review.

### BACKGROUND

Reviewing documents drafted by others can be difficult. Because, sometimes, a reviewer lacks access to materials referred to, but not included, in a draft. For example, a CEO reviewing a draft annual finance report may not have immediate access to all quarterly earnings reports referred to in the draft finance report.

Reviewing (or preparing for filing) draft legal document can be even more difficult. First, liabilities may arise from inaccuracies included in a legal document. For example, a corporation issuing an IPO may be held liable for, sometimes even inadvertent, mistaken disclosure of the corporation's past revenue in a prospectus. Second, legal documents are often complex and incorporate a wide range of information that needs to be verified, under both legal and ethical requirements. For example, a stock prospectus may include a large number of statements concerning a company's past revenues, each of which may need to be verified before the prospectus is distributed to potential inventors. For another example, an IP licensing agreement may include information relating to a large sum of patents and their progenies, the value and subject matter of which need to be separately evaluated. Consequently, reviewing draft legal documents can be both time- and resource-consuming.

The above identified difficulties are reduced or eliminated by the systems and methods disclosed herein.

### SUMMARY

Systems, methods, and non-transitory computer readable storage mediums for collaborative document review are disclosed herein.

In a first aspect of the present disclosure, a method for collaborative document review is provided. In some implementations, the method includes, at a computer system, displaying at least a portion of a hierarchical data structure. Each user in a first plurality of users has an edit privilege to edit the hierarchical data structure. In some implementations, the method also includes obtaining a user selection of a region in the portion of the hierarchical data structure. In some implementations, the method further includes, in response to the user selection of the region, displaying, for each respective user in the first plurality of users, one or more edits associated with the respective user in a corresponding independent panel in a plurality of panels. The plurality of panels is displayed independently of the hierarchical data structure.

In some implementations, a second plurality of users has review privileges to comment on the hierarchical data structure. In some implementations, the method also includes displaying, for a user in the second plurality of users, one or more comments associated with the user in the same or different panel in the plurality of panels. A respective comment is distinct from the one or more edits. In some implementations, the one or more edits and comments are displayed concurrently with the selected region.

In some implementations, the hierarchical data structure comprises a plurality of structural elements. Each structural element in the plurality of structural elements is associated with a universally unique identifier.

In some implementations, the region selected by the user includes a text or non-text element.

In some implementations, the one or more user edits and the one or more comments are displayed in accordance with one or more filtering criteria. In some implementations, the one or more filtering criteria include a user name associated with a respective user in the first plurality of users or the second plurality of users, an importance score associated with a respective user comment, or a type associated with the respective user's comment or edit.

In some implementations, the method also includes updating the displaying of a respective comment or edit in accordance with a change to the document. In some implementations, the updating includes displaying the respective comment or edit at a different location, displaying the respective comment or edit in a different visual manner, or hiding the respective comment or edit from display.

In some implementations, the method further includes incorporating, into the hierarchical data structure, a portion of, but not all, changes corresponding to an edit in the one or more edits.

In some implementations, the method optionally includes displaying a first mark and a second mark for indicating the region. The first and second marks are displayed independent of, but adjacent to, the hierarchical data structure.

In a second aspect of the present disclosure, a method for collaborative review comprises, at a computer system, displaying at least a portion of a hierarchical data structure associated with a transaction, and obtaining a user selection of a region in the portion of the hierarchical data structure. In some implementations, the method also includes, in response to a predefined user action on the region, identifying a statement within the region and displaying one or more compliance items associated with the statement. Each compliance item in the one or more compliance items is associated with a checklist and specifies for the corresponding statement that the compliance item has been at least partially satisfied. The checklist details a plurality of requirements that needs to be fulfilled before completing the transaction.

In some implementations, a requirement in the plurality of requirements includes a legal requirement or a user defined requirement.

In some implementations, completing the transaction includes sending the hierarchical data structure to a third party. In some implementations, the third party is a government agency, an internal or external entity involved in the transaction.

In some implementations, a compliance item, in the one or more compliance items, is associated with two or more checklists.

In some implementations, a compliance item, in the one or more compliance items, is associated with two or more statements in the hierarchical data structure.

In some implementations, the transaction includes an IPO transaction, a merger or acquisition transaction, a rights issue transaction, a debt issuance transaction, or a security related transaction.

In some implementations, the method also includes displaying a portion of the identified statement, adjacent to a compliance item of the one or more compliance items, independently from the hierarchical data structure.

In some implementations, the method further includes detecting a predefined user action on a compliance item in the one or more compliance items and, in response to the detecting, displaying the compliance item in a visually different manner.

In some implementations, the method optionally includes updating, without user intervention, the displaying of the one or more compliance items in accordance with a change to the hierarchical data structure.

In some implementations, the method also includes displaying a report indicating one or more statuses associated with the one or more compliance items.

In a third aspect of the present disclosure, a method for collaborative document review comprises, at a computer system, selecting a checklist synthesis associated with a hierarchical data structure for a transaction. The hierarchical data structure comprises a plurality of structural elements. The checklist synthesis comprises a plurality of compliance items within a checklist. The checklist synthesis is associated with a unique identifier. In the method all or a portion of the compliance items in the plurality of compliance items are displayed. In some implementations, the method also includes, responsive to detecting a predefined user action on a compliance item in the plurality of compliance items, displaying a first portion and a second portion of the hierarchical data structure that are associated with the compliance item. The first portion is in a first structural element and the second portion is in a second structural element in the plurality of structural elements.

In some implementations, the unique identifier corresponds to a version of the checklist synthesis.

In some implementations, completing the transaction includes sending the hierarchical data structure to a third party. The third party is a government agency, an internal or external entity involved in the transaction.

In some implementations, a compliance item, in the one or more compliance items, is associated with two or more checklists.

In some implementations, a compliance item, in the one or more compliance items, is associated with two or more statements in the hierarchical data structure.

In some implementations, the transaction includes an IPO transaction, a merger or acquisition transaction, a rights issue transaction, a debt issuance transaction, or a security related transaction.

In some implementations, the method also includes displaying a portion of the identified statement, adjacent to a compliance item of the one or more compliance items, independently from the hierarchical data structure.

In some implementations, the method also includes displaying a report indicating one or more statuses associated with the one or more compliance items.

In a fourth aspect of the present disclosure, a method for collaborative document review includes, at a computer system, displaying a hierarchical data structure associated with a transaction. The hierarchical data structure comprises a plurality of structural elements. The hierarchical data structure is associated with a checklist synthesis. The checklist synthesis comprises a plurality of compliance items within a checklist, and the checklist synthesis is associated with a unique identifier. In some implementations, the method also includes spawning a branch in a directed acyclic graph. The directed acyclic graph includes a root node associated with a master instance of the hierarchical data structure. In some implementations, the method also includes associating a first instance of the hierarchical data structure with the branch and, responsive to a user request, modifying a portion of a structural element in the plurality of structural elements in the first instance of the hierarchical data structure. In some implementations, the method further includes updating the checklist synthesis to produce an updated checklist synthesis in accordance with the modification. The updated checklist synthesis is associated with a different unique identifier.

In some implementations, the checklist synthesis and the updated checklist synthesis each includes one or more compliance items.

In a fifth aspect of the present disclosure, a method for collaborative document review includes, at a computer system, displaying information identifying one or more documents and, responsive to detecting a predefined user action on the information, identifying a first document in the one or more documents. The predefined user action is performed by a user. In some implementations, the method also includes displaying, independently from the information, one or more portions of a hierarchical data structure associated with a transaction. The hierarchical data structure comprises a plurality of structural elements. The one or more portions are associated with one or more structural elements of the plurality of structural elements. The first document verifies, according to the user, the one or more portions of the hierarchical data structure.

In some implementations the verification includes, in accordance with a determination that a respective portion in the one or more portions of the hierarchical data structure constitutes an assertion of fact or is based on an explicit or implicit assumption of fact, confirming accuracy of the assertion or the assumption of fact using the first document.

In some implementations, the content of the first document is not displayed when one or more steps of the method are executed.

In some implementations, displaying information identifying one or more documents includes hiding from display content of the one or more documents.

In a sixth aspect of the present disclosure, a method for collaborative reviewing includes, at a computer system, obtaining a master instance of a hierarchical data structure associated with a transaction and identifying a verification index associated with the master instance of the hierarchical data structure. The verification index refers to a portion of the master instance of the hierarchical data structure. The portion is configured to be at least partially verified before completing the transaction. In some implementations, the method also includes identifying an evidence index associated with the master instance of the hierarchical data structure. The evidence index refers to information supporting, according to a user, the accuracy of the portion of the master instance of the hierarchical data structure. In some implementations, the method further includes creating a file structure that includes the master instance, the verification index, and the evidence index.

In some implementations, the portion of the master instance of the hierarchical data structure includes one or more statements constituting an assertion of fact or based on an explicit or implicit assumption of fact.

In some implementations, the transaction includes an IPO transaction, a merger or acquisition transaction, a rights issue transaction, a debt issuance transaction, or a security related transaction.

In a seventh aspect of the present disclosure, a method for collaborative review includes, at a computer system, displaying a portion of a hierarchical data structure associated with a transaction and displaying a first panel in a plurality of panels independently of the hierarchical data structure. The first panel includes one or more content items having a first type. In some implementations, the method also includes detecting a first predefined user action and, in response to detecting the first predefined user action, displaying, independently of the hierarchical data structure, a second panel in the plurality of panels. The second panel includes one or more content items having a second type distinct from the first type.

In some implementations, the method further includes, in response to detecting the first predefined user action, hiding from display at least a portion of the first panel.

In some implementations, the method optionally includes detecting a second predefined user action distinct from the first predefined user action and, in response to detecting the second predefined user action, displaying, independently of the hierarchical data structure, the first panel. In some implementations, the method also optionally includes hiding from display the second panel.

Computer systems, and a non-transitory computer readable storage mediums storing one or more programs, which, when executed by a computer, cause the computer to perform one or more steps of one or more above-described methods, as described in the present disclosure, are also disclosed.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a block diagram illustrating a computer system, in accordance with some implementations.

FIG. 2 is a block diagram illustrating a client device, in accordance with some implementations.

FIG. 3 is a block diagram illustrating a server system, in accordance with some implementations.

FIG. 4 is a flow chart illustrating an example file structure of a verification bundle 230, in accordance with some implementations.

FIGS. 5A-5B are flow charts illustrating a first example method for collaborative document review at a client or a server, in accordance with some implementations.

FIGS. 6A-6B are flow charts illustrating a second example method for collaborative document review at a client, in accordance with some implementations.

FIGS. 7A-7B are flow charts illustrating a third example method for collaborative document review at a client or a server, in accordance with some implementations.

FIG. 8 is a flow chart illustrating a fourth example method for collaborative document review at a client or a server, in accordance with some implementations.

FIG. 9 is a flow chart illustrating a fifth example method for collaborative document review at a client or a server, in accordance with some implementations.

FIG. 10 is a flow chart illustrating a sixth example method for collaborative document review at a client or a server, in accordance with some implementations.

FIG. 11 is a flow chart illustrating a seventh example method for collaborative document review at a client or a server, in accordance with some implementations.

### DETAILED DESCRIPTION

The implementations described herein provide techniques for collaborative review of one or more documents (e.g., legal documents). These techniques may significantly increase efficiency in preparing and reviewing draft legal document (e.g., SEC, EPA, or IRS filings, complaints, and motions).

For example, while reviewing a stock prospectus having several paragraphs, a user selects one of the paragraphs (e.g., to indicate a more focused user interest in that paragraph). In response to the user selection of the paragraph, proposed edits or comments by other users are automatically displayed in a panel next to the selected paragraph, so as to provide a unified view of both the stock prospectus and proposed edits or comments to the prospectus by other users (e.g., attorneys or CPAs), thereby facilitating the user's review of the stock prospectus.

In another example, in response to the user selection of the paragraph, a checklist having one or more items that need to be checked before the document related thereto is delivered to potential investors is displayed adjacent to the IPO document. Each item on the checklist details a legal or ethical requirement that need to be fulfilled such as whether the company's revenue for the past three years has been verified, as required by SEC rules, or whether all prior private offerings have been disclosed, as required by the Security Exchange Act of 1934.

In some cases, the checklist is updated automatically based on a modification to the IPO document. For example, when a reviewer removes a paragraph from the IPO document, items on the checklist related to that removed paragraph are removed from the checklist as well.

In still another example, in response to the user selection of a statement concerning past revenue in the stock prospectus, an excerpt of a quarterly financial report is displayed side by side with the stock prospectus; and the excerpt includes information that verifies or supports the statement concerning past revenue.

In another example, a list of verification documents is displayed on the left hand side of a display. When a user selects one of the verification documents, names of one or more other documents are displayed on the right hand side of the display indicating that the selected verification document includes information that tends to prove or verify statements included in the one or more other documents.

In these ways, when a reviewer reviews a draft legal document, information relevant to the draft, such as proposed edits or comments by other drafters, excerpts of other documents verifying material information included in the draft, or a list of items that ought to be verified or checked are displayed, concurrently with the draft or a selected portion of the draft.

These approaches are advantageous. First, a reviewer having concurrent access (i) to a draft document and (ii) to proposed edits or comments thereto, can review or revise the draft more efficiently and effectively. Second, a reviewer having immediate access to secondary material that includes specifics referred to a draft can be more assured of the accuracy and quality of the draft. Third, a reviewer understanding which draft documents include the same piece of information, which can be verified by a verification document, only need to verify that piece of information once, and rest assure that all draft documents are accurate with respect to that information.

Additional details of implementations are now described in relation to the Figures.

FIG. 1 is a block diagram illustrating a computer system 100 for collaborative document reviewing. In some implementations, the computer system 100 includes a client device 102 (“client 102”), a communication network 104, and a server system 106 (“server 106”). In some implementations, the computer system 100 includes two or more clients 102 (e.g., client 102-A, and client 102-B).

In some implementations, the client 102 receives one or more edits 131, one or more comments 132, or one or more documents 133 from the server 106 or from another client (e.g., the client 102-B), and provides a document 133 along with an edit 131 or a comment 132 to a user of the client 102 for edit or for review. In some implementations, the client 102 is a laptop, desktop, tablet computer or a smart phone, equipped with appropriate processing power or software packages.

In some implementations, the computer system 100 includes a document application 120 (e.g., a plug-in or macro in MICROSOFT WORD, or a stand-alone document processing software application), which includes an edits processing module 122, a comments processing module 124, a checklist module 126, and a verification module 128. In some implementations, the client 102 also stores (e.g., temporarily in volatile memory or permanently on a hard drive) one or more documents (e.g., document 110-1 . . . document 110-n)—documents under review by a user of client 102, or documents relevant thereto, such as verification documents).

In some implementations, the edits processing module 122 processes one or more edits received from the server 106 (e.g., edits by other users stored at the server 106), and edits received from a user of the client 102 (via a user input device), adjusts the display of these edits, and incorporates, partially or fully, these edits into a document (e.g., in accordance with a predefined user action).

In some implementations, the comments processing module 124 processes one or more comments received from the server 106 (e.g., comments by other user stored at the server 106), and comments received from a user of the client 102 (via a user input device), and adjust the display of these comments (e.g., in accordance with a predefined user action).

In some implementations, the checklist module 126 processes (e.g., transmits, receives, displays or hides from display) one or more checklists (or compliance items), a portion thereof, or information relating thereto (e.g., metadata) associated with a document under review by a user. For example, the checklist module 126 displays a list of SEC requirements that need to be fulfilled, before a stock prospectus is delivered to potential investors. For another example, the checklist module 126 displays to a user a list of IRS guidelines that must be followed, before a corporate tax return is officially filed.

In some implementations, the checklist module 126 adjusts the display of a checklist or one or more compliance items included therein, in accordance with a predefined user action (e.g., after a claimed deduction is removed from a tax return yet to be filed, an IRS guideline relating to that removed deduction is also removed from display). In some implementations, the checklist module 126 also records status information associated with a compliance item on a checklist (e.g., reviewed and satisfied, reviewed and not satisfied, or not yet reviewed).

In some implementations, the verification module 128 processes (e.g., transmits, receives, displays, or hides from display) one or more documents (also called verification documents), a portion thereof, or information relating thereto (e.g., metadata), which verify information included in another document. For example, the verification module 126 displays a name, a directory path, or an excerpt of a verification document that verifies one or more factual statements or assertions included in a stock prospectus. In some implementations, the verification module 128 generates one or more verification bundles in response to a user request.

In some implementations, the verification module 128 also adjusts the display (e.g., displaying or hiding from display) of verification documents, in accordance with a predefined user action (e.g., after a statement which the verification document verifies is removed by a user from a stock prospectus, a verification document related to the removed statement is also removed from display). In some implementations, the verification module 126 also records status information associated with a document (e.g., fully verified, partially verified, or not verified).

In some implementation, where the computer system 100 includes two or more clients 102, and edits by different users are communicated between these clients 102, directly or indirectly. For example, edits made by user B (e.g., a junior associate attorney) of the client 102-B are transmitted to the client 102-A, where these edits are displayed to user A (e.g., a supervising attorney), thereby bypassing the server 106. In another example, when both user A and user B are reviewing the same document (e.g., the document 110-1), an edit by user A (or the edited document itself) is sent to, and displayed at the client 102-B (e.g., as either an actual edit or a proposed edit to the document 110-1), via a local connection between the client 102-A and the client 102-B (e.g., a Bluetooth connection, a wifi connection, an infrared connection, a cable connect, or a HDMI cable connect), thereby bypassing the communication network 104 (e.g., so as to provide a faster response time). In still another example, when user A makes an edit to the document (e.g. removing a paragraph from the document 110-1), the edit is sent and applied to (or reflected at) the client 102-B, within predefined threshold delays. These approaches are advantageous: Concurrent editing allows two or more users to collaborate on a project, thereby increasing efficiency.

In some implementations, the communication network 104 optionally includes the Internet, one or more local area networks (LANs), one or more wide area networks (WANs), other types of networks, or a combination of such networks.

In some implementations, the server 106 includes a version management module 140, an edits database 142, a comments database 144, a checklist database 146, and a document database 148. In some implementations, the server 106 stores and transmits user comments/edits, and their associated checklist/compliance items, between different clients 102. In some implementations, the server 106 also stores one or more documents (e.g., a draft legal document, or verification or evidence documents relating thereto), using the document database 148. In some implementations, the server stores (e.g., one or more versions of) user edits, user comments, checklists, or compliance items, using a version management system. For example, both a master instance of a document and multiple secondary instances (e.g., modified versions) of the document are stored on the server 106, to achieve version control/management.

In some implementations, the version management module 140 stores user edits, user comments, checklists, or compliance items, using one or more version techniques. In some implementations, each version of a user edit, user comment, checklist, or compliance item, is stored with a unique identifier. In other implementations, some but not all versions of an edit/comment/checklist/compliance item is stored, so as to conserve storage space and to provide efficient retrieval. In some implementations, the version management module 140 is implemented using software packages similar to those used in MKS INTEGRITY, VCS, IBM RATIONAL TEAM CONCERT, VERACITY, FOSSIL, or GNU ARCH.

In some implementations, the edits database 142 stores one or more edits associated with a document, as well as metadata (e.g., timestamps, access privileges, version numbers, or unique identifiers) associated therewith. In some implementations, the edits database 142 is used to retrieve edits (e.g., edits associated with a particular document) stored therein, and transmits them to one or more clients 102, in accordance with a predefined user action (e.g., a user clicks open the particular document or a user request to download the particular document from the server 106). In some implementations, the edits database 142 is used to selectively retrieve from, and transmit to a client 102, edits associated with a document. For example, after determining that a document is associated with a total of ten edits, but that a user of the client 102 has only read permission to five of the ten edits, the edits database 142 is used to retrieve and transmit the five (rather than all ten) edits to the client 102 for display and for review by the user. For another example, after determining that a document is associated with a total of ten edits, but that a user of the client 102 has read, but not write, permission to the ten edits, the edits database 142 is used to retrieve and transmit the ten edits, along with metadata indicating that the ten edits are not modifiable by the user, to the client 102 for display and for review (but not for modification) by the user.

In some implementations, the comments database 144 stores one or more comments (e.g., by the same or different users) associated with a document, and metadata (e.g., timestamps, access privileges, version numbers, or unique identifiers) associated with the one or more comments. In some implementations, the comments database 144 is used to retrieve comments (e.g., comments associated with a particular document) stored therein, and transmits them to one or more clients 102, in accordance with a predefined user action (e.g., a user clicks open the particular document). In some implementations, the comments database 144 is used to selectively retrieve and transmit to a client 102, comments associated with a document. For example, after determining that a document is associated with a total of ten comments, but that a user of the client 102 has only read permission to five of the ten comments, the comments database 144 is used to retrieve and transmit the five (rather than all ten) comments to the client 102 for display and for review by the user. In another example, after determining that a document is associated with a total of ten comments, but a user of the client 102 has read, but not write (e.g., the user cannot delete a comment), permission to the ten comments, the comments database 144 is used to retrieve and transmit the ten comments, along with metadata indicating that the ten comments are not modifiable by the user, to the client 102 for review (but not for modification) by the user.

In some implementations, the checklist database 146 stores one or more checklists (e.g., by the same or different users) associated with a document, and metadata (e.g., timestamps, access privileges, version numbers, or unique identifiers) associated with the one or more checklists. In some implementations, a checklist includes one or more compliance items, and metadata associated therewith (e.g., timestamps, access privileges, version numbers, or unique identifiers).

In some implementations, the checklist database 144 is used to retrieve checklists (e.g., checklists associated with a particular document) stored therein and transmits them to one or more clients 102, in accordance with a predefined user action (e.g., a user clicks open the particular document). In some implementations, the checklist database 144 is used to selectively retrieve and transmit to a client, a checklist associated with a document, when a user has permission (e.g., read or write) to some but all checklists associated with the document. For example, after determining that a document (e.g., a patent application for a method of treating human cancer using radioactive ingredients that pollute drinking water) is associated with a total number of three checklists (e.g., a first checklist for FDA disclosure, a second checklist for USPTO disclosure, and a third checklist for EPA disclosure), but a user (e.g., a patent attorney specialized in medical treatment devices) of the client 102 has only read permission to two of the three checklists (e.g., the first checklist for FDA disclosure, and the second checklist for USPTO disclosure, but not the third checklist for EPA disclosure), the checklist database 144 is used to retrieve and transmit the two (rather than all three) checklists to the client 102 for display and for review by the user. In another example, after determining that a document is associated with a total of ten checklists, but a user of the client 102 has read but not write permission to the ten checklists, the checklist database 144 is used to retrieve and transmit the ten checklists, with metadata indicating that the ten checklists are not modifiable by the user, to the client 102 for display and for review (but not for modification) by the user.

In some implementations, a user has permission or access (e.g., read or write) to some but all compliance items on a checklist. For example, after determining that a document is associated with a checklist having three compliance items (e.g., a first compliance item for FDA disclosure, a second compliance item for USPTO disclosure, and a third compliance item for EPA disclosure), but a user of the client 102 has only read permission to two of the three compliance items (e.g., the first compliance item for FDA disclosure, and the second compliance item for USPTO disclosure, but not the third compliance item for EPA disclosure), the checklist database 144 is used to retrieve and transmit these two (rather than all three) compliance items to the client 102 for display and for review by the user. In another example, after determining that a document is associated with a total of ten compliance items, but a user of the client 102 has read, but not write, permission to the ten compliance items, the checklist database 144 is used to retrieve and transmit the ten compliance items, with metadata indicating that the ten compliance items are not modifiable by the user, to the client 102 for display and for review (but not for modification) by the user.

In some implementations, the document database 148 is used to retrieve documents (e.g., a particular document) stored therein and transmit them to one or more clients 102, in accordance with a predefined user action (e.g., a user request to download the particular document to the client 102). In some implementations, the document database 148 selectively retrieves and transmits to a client documents requested by a user when a user has permission (e.g., read or write) to some but all documents stored in the document database 148.

In some implementations, the access control is achieved in accordance with information stored in the user profile database 148 (e.g., a user's login name, a role, or a user profile). For example, after determining a document is an email between a licensee and its attorney relating to an IP licensing transaction, the document database 146 refuses access to the email by a licensor or its attorney, in absence of an express grant of such access. These approaches are advantageous because they promote security and preserve confidentiality between a client and its representatives (e.g., attorneys).

In some implementations, the document database 146 is used to retrieve and transmit to the client 102 a document (e.g., a draft document that a reviewer would like to review) or one or more items relating thereto (e.g., verification documents, or access/modification history), in accordance with a predefined user action. For example, after a user requests to review verification documents associated with an IPO document, one or more verification documents (e.g., documents having information that verifies statements in the IPO document) are transmitted to the user for review. In another example, in response to a user request, an access or editing history of a document (e.g., which users have modified the document, or at what times the document was modified) is sent to the user. In a third example, in response to a user request for a specific prior version of a draft document, the specified prior version is sent to the user.

FIG. 2 is a block diagram illustrating a client 102 in accordance with some implementations. The client 102, in some implementations, includes one or more processing units CPU(s) 202 (also herein referred to as processors), one or more network interfaces 204, memory 206, an input device 207 (e.g., a keyboard, a mouse, a touchpad, or a touch screen), a display 209, and one or more communication buses 205 for interconnecting these components. The communication buses 205 optionally include circuitry (sometimes called a chipset) that interconnects and controls communications between system components. The memory 206 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 206 optionally includes one or more storage devices remotely located from the CPU(s) 202. The memory 206, or alternatively the non-volatile memory device(s) within the memory 206, comprises a non-transitory computer readable storage medium. In some implementations, the memory 206 or alternatively the non-transitory computer readable storage medium stores the following programs, modules and data structures, or a subset thereof:
an operating system 210, which includes procedures for handling various basic system services and for performing hardware dependent tasks;
a network communication module (or instructions) 212 for connecting the client 102 with other devices (e.g., the server 106 or other clients 102) via one or more network interfaces 204 (wired or wireless), or the communication network 104 (FIG. 1);
a document application 120 for displaying user interface components or controls (e.g., textboxes, buttons, radio buttons, drop-down lists) through which a user reviews or revises a document, which includes:
   an edits processing module 122 for processing edits received from the server 106 or another client 102;
   a comments processing module 124 for processing comments received from the server 106 or another client 102;
   a checklist module 126 for processing checklists or compliance items received from the server 106 or another client 102; and
   a verification module 128 for processing verification documents received from the server 106 or another client 102, and for generating a verification bundle; and
data 220, stored on the client 102, which include:
   a document 110-n, which includes
      one or more comments 222-n (e.g., by one or more users) to the document 110-n;
      one or more edits 224-n (e.g., by one or more users) to the document 110-n;
      one or more compliance items 224-n associated with the document 110-n; and
   a verification bundle 230, which includes
      a master document 232 which includes a (e.g., master or most recent) copy of the document 110-n;
      a verification index 234 which includes one or more references (e.g., pointer or shortcuts, such as file/directory name, page/section/paragraph number) to one or more other documents (e.g., verification documents) relating to the document 110-n; and
      an evidence index 236 which includes one or more references (e.g., pointer or shortcuts, such as file/directory name, page/section/paragraph number) to one or more other documents (e.g., evidence documents) relating to the document 110-n.

In some implementations, the client 102 also includes a display 209. In some implementations, the display 209 includes a TV screen or a computer monitor.

In some implementations, the computer system 100 includes two or more clients 102 (e.g., the client 102-A, and the client 102-B in FIG. 1). In some implementations, the server 106 communicates with two or more clients 102 (the edits processing module 122-A, and the edits processing module 122-B). In some implementations, the version management module 140 on the server 106 collects from and transmits to, comments or edits, both clients 102-A and 102-B, when the client 102-A and the client 102-B share a predefined relationship and users of the respective devices have given permission to the collection of such edits or comments (e.g., two computers owned by attorneys on the same side of a merger and acquisition transaction, within a same range of IP address, or users of the clients 102-A and 102-B are team members, belong to the same organization, or share a common interest). Non-limiting examples of organizations include law firms and agencies. Non-limiting examples of common interest include codefendants in a lawsuit or collaborators in a clinical trial.

In some implementations, one or more of the above identified elements are stored in one or more of the previously identified memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 206 optionally stores a subset of the modules and data structures identified above. Furthermore, the memory 206 may store additional modules and data structures not described above.

FIG. 3 is a block diagram illustrating the server system 106 (“server 106,” also called a server), in accordance with some implementations. The server 106 typically includes one or more processing units CPU(s) 302 (also herein referred to as processors), one or more network interfaces 304, memory 306, and one or more communication buses 308 for interconnecting these components. The communication buses 308 optionally include circuitry (sometimes called a chipset) that interconnects and controls communications between system components. The memory 306 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 306 optionally includes one or more storage devices remotely located from CPU(s) 302. The memory 306, or alternatively the non-volatile memory device(s) within the memory 306, comprises a non-transitory computer readable storage medium. In some implementations, the memory 306 or alternatively the non-transitory computer readable storage medium stores the following programs, modules and data structures, or a subset thereof:
an operating system 310, which includes procedures for handling various basic system services and for performing hardware dependent tasks;
a network communication module (or instructions) 312 for connecting the server 106 with other devices (e.g., one or more electronic devices 102) via the one or more network interfaces 304 (wired or wireless), or the communication network 104 (FIG. 1);
a version management module 140 for applying versioning and access control techniques to edits/comments/checklists/compliance items under management by the server 106;
an edits database 142 for storing and retrieving one or more user edits, in accordance with a communication (e.g., a command or an instruction) from the version management module 140;
a comments database 144 for storing and retrieving one or more user comments, in accordance with a communication (e.g., a command or an instruction) from the version management module 140;
a checklist database 146 for storing and retrieving one or more user checklists or compliance items, in accordance with a communication (e.g., a command or an instruction) from the version management module 140; and
a document database 148 for storing and retrieving one or more documents, in accordance with a communication (e.g., a command or an instruction) from the version management module 140.

In some implementations, one or more of the above identified elements are stored in one or more of the previously mentioned memory devices and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 306 optionally stores a subset of the modules and data structures identified above. Furthermore, the memory 306 optionally stores additional modules and data structures not described above.

Although FIG. 3 shows a “server system 106,” also referred to as a server, FIG. 3 is intended more as functional description of the various features which may be present in server system than as a structural schematic of the implementations described herein. In practice, and as recognized by those of ordinary skill in the art, items shown separately could be combined and some items could be separated.

FIG. 4 is a diagram illustrating an example file structure of a verification bundle 230, in accordance with some implementations.

In some implementations, a verification bundle 230 includes a master document 402, metadata 404 (optional), a verification index 406, and an evidence index 410. In some implementations, the master document is a document (or a shortcut thereto) under review by a user (e.g., a reviewer). In some implementations, the master document is a draft document prepared for filing by another user (e.g., a subordinate to the reviewer, an associate working for the reviewer). For example, the master document is a draft IPO document or a draft licensing agreement to be reviewed for approval by the user, for public filing.

In other implementations, the master document 402 is a reference or shortcut to a document (e.g., such as a pointer or a file shortcut used in MICROSOFT WINDOWS operation system). Including a document shortcut, rather than the actual document itself, is advantageous. Sometimes, a document may have a very large size, the transmission of which would be time- and resource-consuming, or inconvenient.

In some implementations, the metadata 404 include metadata relating to the master document, such as to which other documents (e.g., verification documents or evidence documents) the master document relates, and ownership/access privilege/timestamps/access history associated with the master document.

In some implementations, the verification index 406 includes one or more verification references 408-1 . . . 408-n (e.g., paragraph identifier, citation, or shortcut) referencing one or more portions of the master document 402. As explained in more detail below, a verification reference includes information that refers to one or more statements (e.g., assertions of facts) included in the master document 402. For example, the verification reference 408-1 refers to a statement, included in the master document 402, concerning company A's profit for the year of 2012.

In some implementations, the evidence index 410 includes one or more evidence references 412-1 . . . 412-n (or shortcuts thereto) associated with the master document 402. As explained in more detail below, an evidence references includes information (e.g., file name, directory path, or shortcut) referring to one or more documents that would verify a statement included in the master document. For example, the evidence document 412-1 includes company A's tax return filed with the IRS for the year of 2012, which verifies the statement, included in the master document 402, concerning company A's profit for the year of 2012.

### Display Edits Independently from Selected Text

FIGS. 5A-5B are flow charts illustrating a first example method 500 for collaborative document review at a client or a server, in accordance with some implementations.

In some implementations, at a computer system (e.g., a personal computer, a tablet, or a laptop), at least a portion of a hierarchical data structure is first displayed (502). In some implementations, the hierarchical data structure is visualized as a document (e.g., a MICROSOFT WORD/EXCEL/POWERPOINT document, an OPEN OFFICE document, STAR OFFICE document, or a plain text document) with one or more paragraphs, sections, pages, or portions. In some implementations, at least a portion of the hierarchical data structure includes one or more paragraphs in a MICROSOFT WORD document. In some implementations, the hierarchical data structure includes a document that has one or more organizationally hierarchical elements. For example, a hierarchical data structure may be visualized as a MICROSOFT WORD document with the document being the first level of hierarchy and a paragraph included therein being the second level of hierarchy. In another example, a hierarchical data structure may be visualized as a plain text document.

In some implementations, each user in a first plurality of users (e.g., authors or authorized users) has an edit privilege to edit (e.g., modify) the hierarchical data structure. For example, in some cases, an author can grant other users (e.g., an agent, representative, or attorney for the author) write permission to change/edit the document. For another example, an author (e.g., an agent, representative, or attorney) can grant clients (e.g., an inventor, an applicant) as well as their agents (e.g., general counsel, in house counsel, co-counsel) write permission to change/edit the document, so as to enable the client or their agents to provide edits/comments to the (e.g., draft) document provided to them.

In some implementations, the hierarchical data structure is a secondary instance (or secondary copy) of a file to which only predefined users (e.g., an owner of the document, a super user, or a system administrator) have write permission. In some implementations, after a file is created, a master copy of the file (also called a master file, a master copy, or a master instance) is created; and no user can change or edit the master copy of the file (e.g., content therein or metadata associated therewith, such as creation or modification timestamps, authorship, or version number). In some implementations, e.g., where stricter access control is desired, no user (not even an owner of the master file) has write permission to the master copy once it is created (e.g., to preserve file history and integrity), although view permissions are still available.

In some implementations, after a master copy is created, one or more secondary instances of the file are created and distributed to users, e.g., to protect the integrity of the master copy, while still enabling the users to access (e.g., view or modify) content of the file, albeit using a copy other than the master copy (or master file). For example, secondary copies of a (draft or proposed) licensing contract can be distributed to opposing sides for review and for revision (with counter offers or counter terms), without changing the content of the master copy of the licensing contract. In some implementations, the master copy and the second instances of the same file are associated with metadata (e.g., tags, version numbers, or timestamps), which identify one or more relationships between the master copy and its secondary instances (e.g., which secondary instances correspond to an identified master copy).

In some implementations, a user selects a region in the portion of the hierarchical data structure (504). For example, a user selects a paragraph or a table within a document that includes twenty paragraphs and five tables.

In some implementations, in response to the user selection of the region, for each respective user in the first plurality of users, one or more edits associated with the respective user in a corresponding independent panel in a plurality of panels are displayed, where the plurality of panels are displayed independently of the hierarchical data structure (506). For example, after a user selects a paragraph in a document, user edits (or suggested/proposed edits), by the same user or other users, to the paragraph are displayed automatically (e.g., without user intervention, or a user action in addition to selecting the paragraph) in a panel adjacent to the document (e.g., side by side with the document). In other implementations, no independent panel is used and the user edits are displayed within the document (e.g., in-line comments).

In some implementations, a second plurality of users (e.g., reviewers) has review privileges to comment on, but not to edit, the hierarchical data structure. For example, some users (e.g., legal secretaries assigned to print copies of a document, or documents reviewing attorney, temporary/contract attorney, or discovery specialists) have read, but not write, permission to the document, because it might be necessary to maintain or limit control as to who can modify a document.

In some implementations, for a user in the second plurality of users, one or more comments associated with the user are displayed (516), in the same or a different panel in the plurality of panels, where a respective comment is distinct from the one or more edits (516). For example, a discovery specialist or a document reviewing attorney can comment on the substance of a document (such as identifying the document as attorney client privileged and thus not discoverable, or determining that the document is discoverable and thus should be produced in response to a request for production of documents), in a panel (separate from the panel for proposed edits). In other implementations, comments by several users are displayed in the same panel (e.g., concurrently or otherwise) as user edits, so as to provide an integrated or comprehensive view of the document and its associated comments and edits.

In some implementations, comments are displayed in a different panel than edits are. This approach may similarly facilitate a user's review of a document, as it enables the user to selectively review content relating to the document (e.g., in a comments-only mode or an edits-only mode). In some implementations, user comments are distinct from user edits. For example, user comments are non-editable (e.g., for display only), while user edits are editable (e.g., can be selectively edited/change, or incorporated into a document).

In some implementations, user comments/edits are displayed in a different panel in according with roles associated with the users, e.g., comments/edits by a buyer or its representative are displayed in a first panel, while those by a seller or its representative are displayed in a second panel. This approach is advantageous, as it allows for separate displaying of comments by different types of users, which may facilitate a viewer's review of the document.

In some implementations, comments by one user are selectively displayed to another user, in accordance with predefined access restrictions (e.g., whether a user has been authorized to see comments/edits by other users), or in accordance with roles associated with these users (e.g., whether two users are on a same side of a licensing transaction). For example, in some situations, comments by attorneys for a buyer (e.g., confidential information about the buyer's bottom line position) are not displayed to attorneys for a seller, without express authorization by the buyer. In some implementations, the selective display of user comments is triggered automatically without user intervention (e.g., to provide added security) based on predefined role associated with a user name or login. For example, after user A opens a document drafted by user B, a document application (e.g., a plug-in, such as a WORD macro, or an application in which the document is opened, such as MICROSOFT WORD) detects that user A and user B are both counsels for the same client, and therefore comments by user B are displayed to user A. For another example, if the document application detects that user A represents the licensor in a patent licensing transaction, while user B represents the licensee in the same transaction, and user B has not explicitly or expressly authorized user A to view his/her comments to the draft, the comments by user B are not displayed, or automatically hidden from display, to user A, so as to maintain confidentiality and to prevent inadvertent disclosure, as required by relevant legal and ethical rules.

In some implementations, user comments or edits are encrypted with a private or public key, so as to provide additional security, and, for attorneys, to ensure compliance with ethical and legal duties (e.g., an attorney's duty of confidentiality to clients). In some implementations, users on the same side of a transaction are equipped with (e.g., given) necessary private or public key to decrypt comments by other users on the same side, to facilitate collaborative review.

In some implementations, the hierarchical data structure (e.g., visualized as a WORD document) comprises a plurality of structural elements (e.g., paragraphs or sections) (508). In some implementations, each structural element (e.g., paragraph or section) in the plurality of structural elements is associated with a universally (or globally) unique identifier (508). For example, among twenty documents, each of which includes ten paragraphs, each paragraph in these twenty documents is associated with a unique identifier (e.g., 0001, 0002, 0003 . . . 0200) that uniquely identifies the paragraph. For example, the identifier “0105” identifies (or corresponds to) the 5th paragraph in the 11th document in the twenty documents.

In some implementations, a universally unique identifier is unique with respect to each structural element included in plurality of documents (e.g., all documents stored in the document database 148 in FIG. 1). For example, not only that no two paragraphs from the same document shares the same identifier, but also that no two paragraphs from different documents share the same identifier. In another example, each paragraph in a collection of documents (e.g., all documents stored in a database) is assigned an identifier that has not been previously assigned (e.g., to any other paragraph). In some implementations, the universally unique identifier is generated incrementally (e.g., 0001, 0002, 0003 . . . ). In some implementations, each universally unique identifier is unique across all documents ever created by computer system 100. In some implementations, each universally unique identifier is unique across all documents every processed by version management module 140.

In other implementations, the identifier is unique on a documents level (e.g., with respect to each paragraph within the same document), rather than universally or globally. For example, in some cases, each paragraph in a document is assigned a different identifier, but paragraphs in different documents are assigned the same identifier (e.g., so as to conserve system resource). For example, the first paragraph in one document is assigned the identifier “0001,” while the first paragraph in another document is also assigned the identifier “0001.”

In some implementations, the region selected by the user includes a text or non-text element (510). In some implementations, a text element includes a character, a word, a phrase, a term, a sentence, a paragraph or a section of text; and a non-text element includes a table, a grid, an image, a video, an embedded object into the document. For example, a user can select a region that includes a table, a grid, or an image, embedded in a document and edit or comment on the embedded table, grid, or image. Enabling a user to edit or comment on non-text elements is advantageous: In some cases, a user would like to comment on the formatting of (rather than the text—or content—within) an image or a table.

In some implementations, the one or more edits and comments are displayed concurrently (e.g., at the same time, or within the same windows or browser) with the selected region (518). In some implementations, the one or more edits and comments are displayed adjacent to the selected region, e.g., to enable a user to easily compare the notes/comments with a selected portion of a document.

In some implementations, the one or more user edits and the one or more comments are displayed in accordance with one or more filtering criteria (512), e.g., authorship, ownership, creation or last modified time of a user comment or edit. In some implementations, the one or more filtering criteria include (514) one of: a user name associated with a respective user in the first plurality of users or the second plurality of users (e.g., an edit author's user name), an importance score associated with a respective user comment (e.g., high, medium, or low priority), or a type associated with the respective user's comment or edit (e.g., editable or non-editable, for edit or for display only).

In some implementations, the display of a respective comment or edit is updated in accordance with a change to the document (520). For example, when a portion (e.g., a sentence or paragraph) is moved (e.g., relocated) to a different part of the document (e.g., a different page or under a different heading), or removed from the document, comments or edited associated with that portion are also move or removed.

In some implementations, the updating includes (522) one of: displaying the respective comment or edit at a different location (e.g., relocating a comment or edit), displaying the respective comment or edit in a different visual manner (e.g., with different color, in different font, in different shapes), or hiding the respective comment or edit from display (e.g., removing a comment or edit).

In some implementations, in response to a predefined user action (e.g., a single or double click), incorporating (524), into the hierarchical data structure, a portion of, but not all, changes corresponding to an edit in the one or more edits. For example, a user can selectively or partially include a portion of a suggested edit into a document, such as incorporating only the first two words of an edit (e.g., proposed by another user) that include more than ten words. This approach allows for selective or partial acceptance (or rejection), e.g., non-verbatim, of a suggested or proposed edit to a document.

In some implementations, a first mark and a second mark are displayed (526) to indicate the region selected or highlighted by a user, where the first and second marks are displayed independent of but adjacent to the hierarchical data structure. In some implementations, the first and second marks are of triangle, square, or like shape, to visually indicate to a user the range (e.g., in terms of line numbers) of a region selected.

### Display Compliance Items Associated with Selected Text

FIGS. 6A-6B are flow charts illustrating a second example method 600 for collaborative document review at a client, in accordance with some implementations.

In some implementations, a method for collaborative document review is implemented at a computer system (e.g., a document management server, a laptop or a desktop). In some implementations, at least a portion of a hierarchical data structure associated with a transaction (e.g., several paragraphs included in a merger and acquisition or intellectual property licensing agreement) is displayed to a user (602).

In some implementations, the transaction (622) includes: an IPO transaction, a merger or acquisition (M&A) transaction, a rights issue transaction (e.g., an issue of rights to purchase additional stock by a company to its existing stock holders), a debt issuance transaction (e.g., a municipal or U.S. Treasury bond issuance), or a security related transaction (e.g., a stock issuance). In some implementations, the transaction includes an intellectual property licensing transaction, or a settlement.

In some implementations, after the at least a portion of the hierarchical data structure (e.g., several paragraphs included in a merger and acquisition contract) is displayed, a user selects (e.g., a selection or a highlight) a region (e.g., a word, phrase, sentence, or section) in the portion (e.g., among several paragraphs) of the hierarchical data structure (604). For example, after reviewing several paragraphs of a licensing agreement, a user highlights a background section (or a severability clause or an arbitration clause), to indicate an intent to review that section.

In some implementations, in response to a predefined user action (e.g., a right or double click) on a paragraph in the draft document (e.g., a paragraph about company A's past revenue), compliance items associated with the paragraph are identified and displayed to a reviewer. In another example, after highlighting a section on a client company's past revenue, a user right-clicks the number representing the client company's revenue from last year, and in response to the right click, one or more compliance items associated with that number are displayed (e.g., a requirement under SEC rules that all statements on past revenue be accompanied with warnings to potential inventors that similar results are not guaranteed).

In some implementations, each compliance item in the one or more compliance items is associated with a checklist, each compliance item in the one or more compliance items specifies for the statement that the compliance item has been at least partially (or fully) satisfied, and the checklist details a plurality of requirements that needs to be fulfilled before completing the transaction (612).

In some implementations, a requirement in the plurality of requirements includes a legal requirement or a user defined requirement (614). In some implementations, a legal requirement includes a statutory requirement that statements regarding company revenue must be verified by an independent auditing agency, such as Ernest and Young. In another example, a user defined requirement includes an internal requirement (e.g., a self-imposed requirement, as opposed to a requirement by law) that salary information about board members is considered private and thus is not to be published without express consent of a majority of the board members.

In some implementations, completing the transaction includes sending the hierarchical data structure to a third party (e.g., for review) (616). In some implementations, the third party is one of: a government agency, an internal entity (e.g., a collaborator or supervising reviewer), or an external entity (e.g., an opposing party in a transaction, or an independent contractor) involved in the transaction. In some implementations, the government agency includes an agency charged with supervising or overseeing the transaction (e.g., the Security Exchange Commission in an IPO transaction), or an agency to which the user has a duty to report the transaction (e.g., the Environment Protection Agency in a transaction involving federally protected wetland). For example, in accordance with a statutory requirement, a stock prospectus is sent to the SEC, for record-keeping, for review, for approval, or for publication, before an IPO transaction takes place.

In some implementations, the third party is an internal entity (e.g., a collaborator, a supervising reviewer, or a superior to which the user reports).

In some implementations, the third party and the user have competing or adverse interest in the transaction. For example, the third part is an opposing or opposite party of the transition. In another example, after a licensor completes the proposed licensing agreement, the proposal is sent to a licensee for review or revision, in order to move the transaction forward.

In some implementations, a compliance item, in the one or more compliance items, is associated with two or more checklists (618). For example, a pharmaceutical company's revenue from last year (e.g., a compliance item), when included in an IPO agreement, may belong to two or more different checklists (e.g., a checklist for complying with relevant FDA rules, and a checklist for complying with relevant SEC rules), because approvals from both the SEC and the FDA may be required in some situations. In another example, a board member's salary (e.g., a compliance item) may belong to both an internal checklist (requiring that board member's salary be maintained in confidence), and an external checklist (requiring that a board member's salary be disclosed to the SEC when applying for an exemption relating the sales of security by the board member).

In some implementations, a compliance item, in the one or more compliance items, is associated with two or more statements in the hierarchical data structure (e.g., two or more separate statement in a stock prospectus) (620). For example, the same compliance item (e.g., requiring disclosure of revenue for at least the past two years by a corporation selling securities to the public) corresponds to two separate statements (e.g., a statement of revenue for the last year, and a second statement of revue for the year before least year). In some implementations, a compliance item is associated with a single statement in the hierarchical data structure. For example, a disclosure of revenue for the past year corresponds to one statement (e.g., the statement of revenue for last year).

In some implementations, a portion (e.g., the first three words or phrases) of the identified statement is displayed, adjacent to a compliance item in the one or more compliance items, independently from the hierarchical data structure (624). For example, an excerpt of a paragraph that includes a statement highlighted by a user is displayed, next to or side by side with a compliance item, so as to facilitate a user's review of the compliance item and the portion of the paragraph to which the compliance item relates. In some implementations, the excerpt and the compliance item are displayed independently (e.g., in a different panel) from the hierarchical data structure (e.g., the licensing agreement). For example, the excerpt and the compliance item are displayed in a panel adjacent to the document. In other implementations, the excerpt and the compliance item are displayed as individual text blocks (or bubbles) within the document (e.g., in a fashion similar to how comments are displayed in MICROSOFT WORD 2007).

In some implementations, a user performs a predefined action on a compliance item in the one or more compliance items (e.g., checking off a checkbox associated with a compliance item) (628), e.g., to indicated that the compliance item has been checked and believed to be in compliance. In some implementations, in response to the detecting, the compliance item checked off by the user is then displayed in a visually different manner (630) (e.g., in a different color or font, in a user interface control having a different shape, for example, after a compliance item is checked, the text box in which text relating to the compliance item changes from a square shape to a triangle shape.)

In some implementations, the display of the one or more compliance items is updated (632), without user intervention, in accordance with a change to the hierarchical data structure. For example, after a user removes a paragraph from a document, or relocates the paragraph from the first page to the second page of the document, compliance items associated with the paragraphs are updated (e.g., removed or relocated) accordingly, without requiring the user to refresh or otherwise update the display of compliance items. In another example, after a user removes a sentence (e.g., a statement) from a paragraph, compliance items associated with the sentence is removed, and compliance items with the remaining portion of the paragraph are adjusted or re-arranged visually (e.g., the list including the compliances items is expanded into a longer form, or the remaining compliance items are displayed in larger and thus more noticeable textboxes).

In some implementations, a report indicating one or more statuses associated with the one or more compliance items is displayed (634), e.g., to provide a high level summary of compliance status (e.g., overall status). For example, when requested by a user, a report (e.g., a bar char, a burn chart, a pie chart, a data grid, or a data table) having information, such as which compliance items have been reviewed and checked off, which compliance items have been reviewed but not checked off, and which compliances have not been reviewed at all, is displayed.

### Display Portions of a Document and Corresponding Checklist

FIGS. 7A-7B are flow charts illustrating a third example method 700 for collaborative document review at a client or a server, in accordance with some implementations.

In some implementations, a portion (e.g., an excerpt) of a document corresponding to a checklist is displayed. In some implementations, at a computer system (e.g., a laptop or a desktop computer), a checklist synthesis associated with a hierarchical data structure for a transaction is selected (702). In some implementations, the hierarchical data structure (e.g., a MICROSOFT WORD document) comprises (704) a plurality of structural elements (e.g., paragraphs or sections). For example, a merger and acquisition agreement may include several clauses, each written in a different paragraph or section.

In some implementations, the transaction (712) includes: an IPO transaction, a merger or acquisition (M&A) transaction, a rights issue transaction (e.g., an issue of rights to purchase additional stock by a company to its existing stock holders), a debt issuance transaction (e.g., a municipal or U.S. Treasury bond issuance), or a security related transaction (e.g., a stock issuance). In some implementations, the transaction includes an intellectual property licensing transaction, or a settlement.

In some implementations, a checklist synthesis comprises a plurality of (e.g., a portion of) compliance items within a checklist. In some implementations, a checklist synthesis includes a plurality of compliance items within a single checklist. In some implementations, a checklist synthesis includes a plurality of compliance items from two or more checklist (e.g., a checklist of compliance items for FDA review and a checklist of compliance items for SEC review). In some implementations, a checklist synthesis is associated with a unique identifier (e.g., a checklist synthesis identifier, or a version number). In some implementations, the unique identifier associated with a checklist synthesis corresponds to a version of the checklist synthesis (710).

In some implementations, a portion of (including all) compliance items in a plurality of compliance items are displayed (714).

In some implementations, responsive to detecting a predefined user action on a compliance item in the plurality of compliance items (716): a first portion (e.g., a first paragraph) and a second portion (e.g., a second paragraph) of the hierarchical data structure (e.g., a document) that are associated with the compliance item are displayed (718). In some implementations, the first portion is in a first structural element (e.g., one paragraph in a WORD document) in the plurality of structural elements (e.g., all paragraphs included in the WORD document) and the second portion is in a second structural element (a different paragraph in the same WORD document) in the plurality of structural elements. For example, after a user clicks a compliance item relating to a company's past revenue, both a statement (e.g., a sentence or paragraph) about the company's revenue information from last year, and a statement (e.g., another sentence or paragraph) about the company's revenue information from the year before last year, are displayed, e.g., so as to provide the user an overview of what information included in a document is relevant to the compliance item selected by the user. In some implementations, the portion of compliance items are displayed adjacent to first portion and the second portion.

In some implementations, completing the transaction includes sending the hierarchical data structure to a third party (e.g., for review) (720). In some implementations, the third party is one of: a government agency, an internal entity (e.g., a collaborator or supervising reviewer), or an external entity (e.g., an opposing party in a transaction, or an independent contractor) involved in the transaction. In some implementations, the government agency includes an agency charged with supervising or overseeing the transaction (e.g., the Security Exchange Commission in an IPO transaction), or an agency to which the user has a duty to report the transaction (e.g., the Environment Protection Agency in a transaction involving federally protected wetland). For example, in accordance with a statutory requirement, a stock prospectus is sent to the SEC, for record-keeping, for review, for approval, or for publication, before an IPO transaction takes place.

In some implementations, the third party is an internal entity (e.g., a collaborator, a supervising reviewer, or a superior to which the user reports).

In some implementations, the third party and the user have competing or adverse interest in the transaction. For example, the third part is an opposing or opposite party of the transition. In another example, after a licensor completes the proposed licensing agreement, the proposal is sent to a licensee for review or revision, in order to move the transaction forward.

In some implementations, the third party and the user have competing or adverse interest in the transaction. For example, the third party is an opposing or opposite party of the transaction. For example, after a user completes the proposed licensing agreement, the proposal is sent to a licensor for review or revision, in order to move the transaction forward.

In some implementations, a compliance item, in the one or more compliance items, is associated with two or more checklists (708). For example, a pharmaceutical company's revenue from last year (e.g., a compliance item), when included in an IPO agreement, may belong to two or more different checklists (e.g., a checklist for complying with relevant FDA rules, and a checklist for complying with relevant SEC rules), because approvals from both the SEC and the FDA may be required in some situations. In another example, a board member's salary (e.g., a compliance item) may belong to both an internal checklist (requiring that board member's salary be maintained in confidence), and an external checklist (requiring that a board member's salary be disclosed to the SEC when applying for an exemption relating the sales of security by the board member).

In some implementations, a compliance item, in the one or more compliance items, is associated with two or more statements in the hierarchical data structure (e.g., two or more separate statement in a stock prospectus) (710). For example, the same compliance item (e.g., requiring disclosure of revenue for at least the past two years by a corporation selling securities to the public) corresponds to two separate statements (e.g., a statement of revenue for the last year, and a second statement of revue for the year before least year). In some implementations, a compliance item is associated with a single statement in the hierarchical data structure. For example, a disclosure of revenue for the past year corresponds to one statement (e.g., the statement of revenue for last year).

In some implementations, a portion (e.g., the first three words or phrases) of the identified statement is displayed, adjacent to a compliance item of the one or more compliance items, independently from the hierarchical data structure (722). For example, an excerpt of a paragraph that includes a statement highlighted by a user is displayed, next to or side by side with a compliance item, so as to facilitate a user's review of the compliance item and the portion of the paragraph to which the compliance item relates. In some implementations, the excerpt and the compliance item are displayed independently (e.g., in a different panel) from the hierarchical data structure (e.g., the licensing agreement). For example, the excerpt and the compliance item are displayed in a panel adjacent to the document. In other implementations, the excerpt and the compliance item are displayed as individual text blocks (or bubbles) within the document (e.g., in a fashion similar to how comments are displayed in MICROSOFT WORD 2007).

In some implementations, a report indicating one or more statuses associated with the one or more compliance items is displayed (724), e.g., to provide a high level summary of compliance status (e.g., overall status). For example, when requested by a user, a report (e.g., a bar char, a burn chart, a pie chart, a data grid, or a data table) having information, such as which compliance items have been reviewed and checked off, which compliance items have been reviewed but not checked off, and which compliances have not been reviewed at all, is displayed.

### Updating Checklist

FIG. 8 is a flow chart illustrating a fourth example method 800 for collaborative document review at a client or a server, in accordance with some implementations.

In some implementations, a hierarchical data structure associated with a transaction is displayed (802). In some implementations, the hierarchical data structure comprises a plurality of structural elements (804). For example, in some cases, the hierarchical data structure is visualized as a WORD document or a plain ASCII text document including several paragraphs.

In some implementations, the hierarchical data structure is associated with a checklist synthesis that comprises a plurality of compliance items within a checklist. For example, the hierarchical data structure is visualized in IP licensing agreement (e.g., written in a MICROSOFT WORD format), and the checklist synthesis includes several compliance items relating to different clauses of the IP license agreement, which need to be verified before the IP licensing agreement is sent to opposing party for review.

In some implementations, the checklist synthesis is associated with a unique identifier, such as a version number, a timestamp, or an identifier assigned by a user or by a document management system.

In some implementations, a branch (e.g., a vertex) in a directed acyclic graph is spawned, where the directed acyclic graph includes a root node associated with a master instance of the hierarchical data structure (810). For example, the IP licensing document is first analyzed using a computer algorithm relating to graph theory A master instance of the licensing agreement represents a root node in an acyclic graph. Secondary instances of the licensing agreement represent sub-nodes in the acyclic graph. Branches in the acyclic graph represent the relationship between a secondary instance and the master instance (e.g., a secondary instance is a first, second, or third version of the master instance).

In some implementations, a first instance of the hierarchical data structure is associated with the branch (812). For example, a draft IP licensing agreement prepared by a licensor is identified as a first secondary instance (e.g., a first sub-node) of a licensing agreement, and another draft prepared by a licensee in the transaction is identified as another secondary instance (e.g., a second sub-node) of the licensing agreement.

In some implementations, responsive to a user request modifying a portion of a structural element (e.g., removing a sentence from a paragraph) in the plurality of structural elements in the first instance of the hierarchical data structure, the checklist synthesis is updated to produce an updated checklist synthesis in accordance with the modification (814). For example, after a user removed a statement regarding past revenue from a stock prospectus, checklist synthesis is updated by removing compliance items relating to statements concerning past revenue.

In some implementations, the updated checklist synthesis is associated with a unique identifier. For example, in some instances, a modified checklist synthesis is associated with a different identifier (e.g., a different version number) from the original checklist synthesis (e.g., an unmodified version), to facilitate version management of the checklist synthesis.

In some implementations, the checklist synthesis and the updated checklist synthesis each includes one or more compliance items (808). For example, both an original checklist synthesis (associated with a first draft) and an updated checklist synthesis (updated in accordance with a user modification to the first draft) include one or more compliance items.

In some implementations, the transaction (806) includes: an IPO transaction, a merger or acquisition (M&A) transaction, a rights issue transaction (e.g., an issue of rights to purchase additional stock by a company to its existing stock holders), a debt issuance transaction (e.g., a municipal or U.S. Treasury bond issuance), or a security related transaction (e.g., a stock issuance). In some implementations, the transaction includes an intellectual property licensing transaction, or a settlement.

### Verification

FIG. 9 provides a flow chart illustrating a fifth example method 900 for collaborative document review at a client or a server, in accordance with some implementations.

In some implementations, information (e.g., a file name, a directory path, or a file identifier) identifying one or more documents (e.g., one or more verification documents) is displayed (902). For example, file names identifying financial documents for several quarters of the year 2012 (e.g., FINANCIAL_STATEMENT_{—}2012_Q1.doc . . . FINANCIAL_STATEMENT_{—}2012_Q4.doc) are displayed to a user.

In some implementations, responsive to (906) detecting a predefined user action (e.g., a mouse click or a mouse hover) on information identifying a first document in the one or more documents, one or more portions of a hierarchical data structure associated with a transaction are displayed independently from the information (908). In some implementations, the predefined user action is performed by a user.

For example, from a list of file names (e.g., 2012_Quarter_{—}1_earnings.doc, 2012_Quarter_{—}2_earnings.doc . . . 2012_Quarter_{—}4_earnings.doc), a user clicks on or hovers over a file name representing an earnings statement for the first quarter in 2012 (e.g., 2012_Quarter_{—}1_earnings.doc), several paragraphs relating to the company's second quarter earnings in 2012, included in a stock prospectus, are displayed side by side with the file name (2012_Quarter_{—}1_earnings.doc)

In some implementations, content of the first document is not displayed and only file names are displayed, because sometimes, a file name is presumed to be descriptive of a file's actual content. For example, the file named Company1_{—}2012_Quarter_{—}1_earnings.doc is presumed to include information relation to Company1's earning information in the first quarter of 2012.

In some implementations, the hierarchical data structure comprises a plurality of structural elements (e.g., paragraphs or clauses), and the one or more portions are associated with one or more structural elements of the plurality of structural elements (e.g., one or more sentences within the paragraphs or clauses) (910).

In some implementations, the first document (e.g., a verification document) verifies, according to the user (e.g., based on user's understanding or belief), the one or more portions of the hierarchical data structure. In some implementations, verification is defined, in accordance with a determination that a respective portion in the one or more portions of the hierarchical data structure constitutes an assertion of fact or is based on an explicit or implicit assumption of fact, confirming accuracy of the assertion or the assumption of fact using the first document. For example, the file Company1_{—}2012_Quarter_{—}1_earnings.doc is believed by a user, to include information (e.g., a company's earnings in the first quarter of 2012) that can verify (e.g., confirm, support, or establish, conclusively or partially, the truth of) a statement in a stock prospectus relating to Company1's earnings in the first quarter of 2012.

In some implementations, no actual content from a document to be verified (e.g., the IPO document) is displayed. These approaches are advantageous, because a file name is usually much more concise than the file's actual content, and screen real estate is conserved when only file names are displayed.

In some implementations, the transaction is an IPO transaction, a merger or acquisition (M & A) transaction, a rights issue transaction (e.g., issue of rights to buy additional securities in a company made to the company's existing security holders), a debt issuance transaction (e.g., a municipal or U.S. Treasury bond issuance), or a security related transaction (e.g., a stock issuance). In some implementations, the transaction includes a licensing transaction or a settlement.

### Verification Bundle

FIG. 10 provides a flow chart illustrating a sixth example method 1000 for collaborative document review at a client or a server, in accordance with some implementations.

In some implementations, a master instance of a hierarchical data structure associated with a transaction is obtained (1002). In other implementations, secondary instances (e.g., other copies) of the hierarchical data structure are also obtained.

In some implementations, a verification index (e.g., a data structure or a data file) associated with the master instance of the hierarchical data structure is identified (1006), e.g., from documents stored in the document database 148 (FIG. 1). In some implementations, the verification index (e.g., a paragraph number, a section number, or a heading number) refers to a portion (e.g., a paragraph, a section, or a heading, respectively) of the master instance of the hierarchical data structure, where the portion is configured to be at least partially verified before completing the transaction. For example, the verification index is a paragraph number which refers to a paragraph in a stock prospectus concerning company A's revenue in the year of 2012, which needs to be verified before the stock prospectus is filed with the SEC or delivered to potential investors.

In some implementations, an evidence index associated with the master instance of the hierarchical data structure is then identified (1010). In some implementations, the evidence index is or refers to information supporting, according to a user, the accuracy of the portion of the master instance of the hierarchical data structure. In some implementations, the evidence index includes a reference to a file (e.g., a link thereto) or the file itself that provides evidence (or verifies) a statement included in the master instance. For example, the verification index is a URL to company A's tax return filed with the IRS for the year of 2012, which provides evidence or verifies a paragraph included in a stock prospectus concerning company A's revenue for the year of 2012.

In some implementations, a data structure (e.g., a data file, a data sheet, a data bundle, and a data package) that includes the master instance, the verification index, and the evidence index is created (1012). For example, a data pack including the master file, the verification index, and the evidence index is generated as a PDF file. In some implementations, the data structure is also encrypted.

In some implementations, the portion of the master instance of the hierarchical data structure includes one or more statements constituting an assertion of fact or based on an explicit or implicit assumption of fact. For example, a statement concerning the priority date of a patent involved in an IP licensing transaction constitutes an assertion of fact as to the patent's priority date. In another example, a statement concerning issuance of a patent involved in an IP licensing transaction constitutes an explicit or implicit assumption of fact that the patent is valid as far as licensing is concerned.

In some implementations, the transaction includes: an IPO transaction, a merger or acquisition (M&A) transaction, a rights issue transaction (e.g., an issue of rights to purchase additional stock by a company to its existing stock holders), a debt issuance transaction (e.g., a municipal or U.S. Treasury bond issuance), or a security related transaction (e.g., a stock issuance). In some implementations, the transaction includes an intellectual property licensing transaction, or a settlement.

### Mode Transition

FIG. 11 provides a flow chart illustrating a seventh example method 1100 for collaborative document review at a client or a server, in accordance with some implementations.

In some implementations, a portion of a hierarchical data structure associated with a transaction is displayed (1102). In some implementations, the transaction (1104) includes: an IPO transaction, a merger or acquisition (M&A) transaction, a rights issue transaction (e.g., an issue of rights to purchase additional stock by a company to its existing stock holders), a debt issuance transaction (e.g., a municipal or U.S. Treasury bond issuance), or a security related transaction (e.g., a stock issuance). In some implementations, the transaction includes an intellectual property licensing transaction, or a settlement.

In some implementations, a first panel (e.g., a panel for showing user comments) in a plurality of panels is also displayed independently of the hierarchical data structure. In some implementations, the first panel includes one or more content items having a first type (e.g., user comments) (1106).

In some implementations, a first predefined user action (e.g., such as a mouse click on an “edits or comments” button to show user edits) is detected (1108). In some implementations, in response to detecting the first predefined user action: a second panel (e.g., another panel for showing user edits) in the plurality of panels is displayed independently of the hierarchical data structure (1110). The second panel includes one or more content items having a second type (e.g., user edits, also called proposed edits or suggested edits) distinct from the first type (e.g., user comments).

In some implementations, in response to detecting the first predefined user action (e.g., the mouse click on the “edits or comments” button): at least a portion of the first panel is hidden from display (1112). For example, when a user enters an edits-only mode (e.g., by clicking on the “edits or comments” button), user comments are hidden or removed from display, while user edits are displayed or maintained.

In some implementations, a second predefined user action distinct from the first predefined user action is then detected (1114). In some implementations, in response to detecting the second predefined user action (e.g., the mouse hover, as opposed to the mouse click): the first panel is displayed independently of the hierarchical data structure; and the second panel is hidden from display (1116).

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first mark could be termed a second mark, and, similarly, a second mark could be termed a first mark, without changing the meaning of the description, so long as all occurrences of the “first mark” are renamed consistently and all occurrences of the “second mark” are renamed consistently. The first mark, and the second mark are both marks, but they are not the same mark.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method, comprising:
at a computer system:
displaying at least a portion of a hierarchical data structure, wherein each user in a first plurality of users has an edit privilege to edit the hierarchical data structure;
obtaining a user selection of a region in the portion of the hierarchical data structure; and
in response to the user selection of the region:
displaying, for each respective user in the first plurality of users, one or more edits associated with the respective user in a corresponding independent panel in a plurality of panels, wherein the plurality of panels are displayed independently of the hierarchical data structure.

2. The method of claim 1, wherein each user in a second plurality of users has review privileges to comment on the hierarchical data structure, the method further comprising:
displaying, for a user in the second plurality of users, one or more comments associated with the user in a same or different panel in the plurality of panels, wherein a comment in the one or more comments is distinct from the one or more edits.

3. The method of claim 2, wherein the one or more edits, for each respective user in the first plurality of users, and the one or more comments for the user in the second plurality of users are displayed concurrently with the selected region.

4. The method of claim 1, wherein the hierarchical data structure comprises a plurality of structural elements, and wherein each structural element in the plurality of structural elements is associated with a universally unique identifier.

5. The method of claim 1, wherein the region selected by the user includes a text or non-text element.

6. The method of claim 2, wherein the one or more user edits and the one or more comments are displayed in accordance with one or more filtering criteria.

7. The method of claim 6, wherein the one or more filtering criteria include one of: a user name associated with a user in the first plurality of users or the second plurality of users, an importance score associated with a user comment, or a type associated a user comment or a user edit.

8. The method of claim 2, the method further comprising:
updating the displaying of a comment or an edit in accordance with a change to the hierarchical data structure.

9. The method of claim 8, wherein the updating includes one of: displaying the comment or edit at a different location, displaying the comment or edit in a different visual manner, or hiding the comment or edit from display.

10. The method of claim 1, the method further comprising incorporating into the hierarchical data structure less than all the changes specified by an edit in the one or more edits associated with a respective user in the first plurality of users.

11. The method of claim 1, further comprising:
displaying a first mark and a second mark for indicating the region, wherein the first and second marks are displayed independent of but adjacent to the hierarchical data structure.

12. The method of claim 2, wherein
each user in the first plurality of users is other than any user in the second plurality of users, and
each user in the second plurality of users is other than any user in the first plurality of users.

13. A method, comprising:
at a computer system:
displaying at least a portion of a hierarchical data structure associated with a transaction;
obtaining a user selection of a region in the portion of the hierarchical data structure; and
in response to a predefined user action on the region:
identifying a statement within the region; and
displaying one or more compliance items associated with the statement, wherein
each compliance item in the one or more compliance items is associated with a checklist,
each compliance item in the one or more compliance items is configured to specify for the statement that the compliance item has been at least partially satisfied, and
the checklist is configured to detail a plurality of requirements that need to be fulfilled before completing the transaction.

14. The method of claim 13, wherein a requirement in the plurality of requirements includes a legal requirement or a user defined requirement.

15. The method of claim 13, wherein completing the transaction includes sending the hierarchical data structure to a third party, wherein the third party is one of: a government agency, an internal entity involved in the transaction, or external entity involved in the transaction.

16. The method of claim 13, wherein a compliance item in the one or more compliance items is associated with two or more checklists.

17. The method of claim 13, wherein a compliance item in the one or more compliance items is associated with two or more statements in the hierarchical data structure.

18. The method of claim 13, wherein the transaction includes: an IPO transaction, a merger or acquisition transaction, a rights issue transaction, a debt issuance transaction, or a security related transaction.

19. The method of claim 13, the method further comprising:
displaying a portion of the identified statement, adjacent to a compliance item in the one or more compliance items, independently from the hierarchical data structure.

20. The method of claim 13, the method further comprising:
detecting a predefined user action on a compliance item in the one or more compliance items; and
in response to the detecting:
displaying the compliance item in a visually different manner.

21. The method of claim 13, further comprising:
updating, without user intervention, the displaying of the one or more compliance items associated with the statement in accordance with a change to the hierarchical data structure.

22. The method of claim 13, the method further comprising:
displaying a report indicating one or more statuses associated with the one or more compliance items associated with the statement that are displayed in response to the predefined user action on the region.

23. A method, comprising:
at a computer system:
selecting a checklist synthesis associated with a hierarchical data structure for a transaction, wherein
the hierarchical data structure comprises a plurality of structural elements,
the checklist synthesis comprises a plurality of compliance items within a checklist, and
the checklist synthesis is associated with a unique identifier,
displaying all or a portion of the compliance items in the plurality of compliance items; and
responsive to detecting a predefined user action on a compliance item in the plurality of compliance items:
displaying a first portion and a second portion of the hierarchical data structure that are associated with the compliance item, wherein the first portion is in a first structural element in the plurality of structural elements and the second portion is in a second structural element in the plurality of structural elements.

24. The method of claim 23, wherein the unique identifier corresponds to a version of the checklist synthesis.

25. The method of claim 23, the method further comprising:
completing the transaction, including sending the hierarchical data structure to a third party, wherein the third party is one of: a government agency, an internal entity involved in the transaction or an external entity involved in the transaction.

26. The method of claim 23, wherein a compliance item, in the one or more compliance items, is associated with two or more checklists.

27. The method of claim 23, wherein the transaction includes: an IPO transaction, a merger or acquisition transaction, a rights issue transaction, a debt issuance transaction, or a security related transaction.

28. The method of claim 23, further comprising:
displaying a report indicating one or more statuses associated with the plurality of compliance items.

29. A method, comprising:
at a computer system:
displaying a hierarchical data structure associated with a transaction, wherein
the hierarchical data structure comprises a plurality of structural elements,
the hierarchical data structure is associated with a checklist synthesis,
the checklist synthesis comprises a plurality of compliance items within a checklist, and
the checklist synthesis is associated with a unique identifier,
spawning a branch in a directed acyclic graph, the directed acyclic graph having a root node associated with a master instance of the hierarchical data structure;
associating a first instance of the hierarchical data structure with the branch; and
responsive to a user request modifying a portion of a structural element in the plurality of structural elements in the first instance of the hierarchical data structure,
updating the checklist synthesis to produce an updated checklist synthesis in accordance with the modification, wherein the updated checklist synthesis is associated with a different unique identifier.

30. The method of claim 29, wherein the checklist synthesis and the updated checklist synthesis each includes one or more compliance items.

31. A method, comprising:
at a computer system:
displaying information identifying one or more documents;
responsive to detecting a predefined user action on information identifying a first document in the one or more documents, wherein the predefined user action is performed by a user:
displaying, independently from the information, one or more portions of a hierarchical data structure associated with a transaction, wherein
the hierarchical data structure comprises a plurality of structural elements,
the one or more portions are associated with one or more structural elements in the plurality of structural elements; and
wherein the first document verifies, according to the user, the one or more portions of the hierarchical data structure.

32. The method of claim 31, wherein the verification includes:
in accordance with a determination that a respective portion in the one or more portions of the hierarchical data structure constitutes an assertion of fact or is based on an explicit or implicit assumption of fact:
confirming an accuracy of the assertion of fact or the explicit or implicit assumption of fact using the first document.

33. The method of claim 31, wherein the steps recited in claim 31 are performed without displaying content of the first document.

34. The method of claim 31, wherein the displaying information identifying one or more documents includes: hiding from display content of the one or more documents.

35. A method, comprising:
at a computer system,
obtaining a master instance of a hierarchical data structure associated with a transaction;
identifying a verification index associated with the master instance of the hierarchical data structure, wherein the verification index refers to a portion of the master instance of the hierarchical data structure, and wherein the portion is configured to be at least partially verified before completing the transaction;
identifying an evidence index associated with the master instance of the hierarchical data structure, wherein the evidence index refers to information supporting, according to a user, the accuracy of the portion of the master instance of the hierarchical data structure; and
creating a file structure that includes the master instance, the verification index, and the evidence index.

36. The method of claim 35, wherein the portion of the master instance of the hierarchical data structure includes one or more statements constituting an assertion of fact or based on an explicit or implicit assumption of fact.

37. The method of claim 35, where in the transaction includes: an IPO transaction, a merger or acquisition transaction, a rights issue transaction, a debt issuance transaction, or a security related transaction.

38. A method comprising:
at a computer system,
displaying a portion of a hierarchical data structure associated with a transaction;
displaying a first panel in a plurality of panels independently of the hierarchical data structure, wherein the first panel includes one or more content items having a first type;
detecting a first predefined user action; and
in response to detecting the first predefined user action:
displaying, independently of the hierarchical data structure, a second panel in the plurality of panels, wherein the second panel includes one or more content items having a second type distinct from the first type.

39. The method of claim 38, further comprising:
in response to detecting the first predefined user action:
hiding from display at least a portion of the first panel.

40. The method of claim 38, further comprising:
detecting a second predefined user action distinct from the first predefined user action; and
in response to detecting the second predefined user action:
displaying, independently of the hierarchical data structure, the first panel; and
hiding from display the second panel.
